(19) United States
(12) Patent Application Publication
(10) Pub. No.: US 2024/0298777 A1
(43) Pub. Date: Sep. 12, 2024

(54) Nail trimming tool

(71) Applicant: Victor Scaperotti, Carmel, NY (US)

(72) Inventor: Victor Scaperotti, Carmel, NY (US)

(21) Appl. No.: 18/181,945

(22) Filed: Mar. 10, 2023

(51) Int. Cl. A45D 29/02; A01K 13/00

(52) U.S. Cl. CPC A45D 29/02; A01K 13/00

(57) ABSTRACT

A nail trimming tool includes a first blade and a second blade. The first blade forms a first crescent, wherein the second blade forms a second crescent. The first blade and the second blade are oriented to mirror each other on a vertical plane. A concave surface of the first blade comprises a cutting edge of the first blade and a concave surface of the second blade comprises a cutting edge of the second blade. The first blade and the second blade are oriented with a space between them, wherein a nail to be trimmed by the first blade and by the second blade can be placed inside the space.

### BACKGROUND

For health and safety reasons, dogs and many other pets need to have their nails cut. Pets have either nails or claws that enable them to climb, defend themselves and catch prey. Since most pets, such as dogs, cats, birds, and other small critters do not use nails or claws like they do in the wild, their nails or claws continue to grow. A groomer or owner of the pet must regularly inspect and trim the nails or claws. Overgrown nails can cause damage to the skin and personal belongings of the pet owner. Also, long nails can curl around if left unattended and lead to a painful embedded. Therefore, nails need to be maintained, which includes cutting or trimming pets' nails.

Most pets dislike having their nails cut. During this procedure, the animals can become scared and agitated, and may struggle and move unexpectedly, which can make it tricky to use the traditional scissor and guillotine-style nail clippers because with one slight movement, the clippers can accidentally cut into the quick of the nail, causing pain, bleeding, and risking infection. Because of the risks associated with nail trimming, many pet owners will chose to incur the costs of utilizing a professional to trim a pet's nails. Not only does this represent what can be a significant cost over time, professionals are not necessarily infallible, just more experienced, so the risks to the pets, while diminished, still exist.

Various attempts have been made to integrate safety features into nail trimmers or clippers, but while these features have increased the costs and complexity of the nail trimmers, the risk of injury to the pets has still persisted. For example, certain trimmers have utilized safety bars, rotating features, and/or sensors that trigger lights. These safety features are all flawed: the safety bar is inoperable if a pet struggles too much because the nail is led through to such a small area, the rotating features produce vibrations and noise that can agitate a pet so a pet may not cooperate at all for the procedure, and sensors require exact positioning that is difficult with a squirming pet, in order for the procedure to be effective. Additionally, an individual operating a nail trimmer with a known safety feature may be less careful because of a misguided understanding that the nail trimmer cannot injure the pet. Thus, a need persists for a safe device and method for cutting the nails of a pets.

### SUMMARY

Shortcomings of the prior art are overcome, and additional advantages are provided by a nail trimming tool. The tool includes, for example: a first blade and a second blade, where the first blade forms a first crescent, where the second blade forms a second crescent, where the first blade and the second blade are oriented to mirror each other on a vertical plane, where a concave surface of the first blade comprises a cutting edge of the first blade and a concave surface of the second blade comprises a cutting edge of the second blade, where the first blade and the second blade are oriented with a space between a portion of the first blade and a portion of the second blade, where a nail to be trimmed by the first blade and by the second blade can be placed inside the space.

Shortcomings of the prior art are overcome, and additional advantages are provided through the provision of a method for using a nail trimming tool. The method includes, for example: obtaining a nail trimming tool, the nail trimming tool comprising: a first blade and a second blade, where the first blade forms a first crescent, where the second blade forms a second crescent, where the first blade and the second blade are oriented to mirror each other on a vertical plane, where a concave surface of the first blade comprises a cutting edge of the first blade and a concave surface of the second blade comprises a cutting edge of the second blade, where the first blade and the second blade are oriented with a space between a portion of the first blade and a portion of the second blade, where a nail to be trimmed by the first blade and by the second blade can be placed inside the space; and a handle attached to the first blade and to the second blade, where the handle controls the first blade and the second blade such that the first blade and the second blade move into a first position and into a second position, where in the first position the first blade and the second blade form the space and the second position, the first blade and the second blade move toward the vertical plane from opposing horizontal orientation; utilizing the handle to orient the nail trimming tool into the first position; placing the nail to be trimmed inside the space; and utilizing the handle to orient the nail trimming tool into the second position, where based on orienting the nail trimming tool into the second position, the nail is clipped.

Shortcomings of the prior art are overcome, and additional advantages are provided by a nail trimming tool. The tool includes, for example: a first blade and a second blade, where the first blade forms a first crescent, where the second blade forms a second crescent, where the first blade and the second blade are oriented to mirror each other on a vertical plane, where a concave surface of the first blade comprises a cutting edge of the first blade and a concave surface of the second blade comprises a cutting edge of the second blade, where the first blade and the second blade are oriented with a space between a portion of the first blade and a portion of the second blade, where a nail to be trimmed by the first blade and by the second blade can be placed inside the space; a handle attached to the first blade and to the second blade, where the handle controls the first blade and the second blade such that the first blade and the second blade move into a first position and into a second position, where in the first position the first blade and the second blade form the space and the second position, the first blade and the second blade move toward the vertical plane from opposing horizontal orientations; where based on moving toward the vertical plane, the cutting edge of the first blade and the cutting edge of the second blade trim the nail to be trimmed placed inside the space.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 is a block diagram that illustrates various aspects of some embodiments of the present invention;

FIG. 3 illustrates some aspects of the certain functionalities of various embodiments of the present invention;

FIG. 4 illustrates some aspects of the certain functionalities of various embodiments of the present invention;

FIG. 5 depicts a workflow that illustrates various aspects of some embodiments of the present invention;

FIG. 6 illustrates some aspects of the certain functionalities of various embodiments of the present invention; and

FIG. 7 depicts one example of a machine learning training system used in accordance with one or more aspects of the present invention.

### DETAILED DESCRIPTION

The accompanying figures, in which like reference numerals refer to identical or functionally similar elements throughout the separate views and which are incorporated in and form a part of the specification, further illustrate the present implementation and, together with the detailed description of the implementation, explain the principles of the present implementation. As understood by one of skill in the art, the accompanying figures are provided for ease of understanding and illustrate aspects of certain examples of the present implementation. The implementation is not limited to the examples depicted in the figures.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., mechanically, electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

The terms “including” and “comprising”, as used herein, mean the same thing.

The terms “substantially”, “approximately”, “about”, “relatively”, or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to #10%, such as less than or equal to +5%, such as less than or equal to +2%, such as less than or equal to +1%, such as less than or equal to +0.5%, such as less than or equal to +0.2%, such as less than or equal to +0.1%, such as less than or equal to +0.05%. If used herein, the terms “substantially”, “approximately”, “about”, “relatively,” or other such similar terms may also refer to no fluctuations, that is, +0%.

As used herein, the term “adjacent” when used with respect to two aspects in a structure means no other such structure is located between the two initial structures. Adjacent structures may be contiguous, such that they abut each other, or the adjacent sites may be non-contiguous, having an intervening or interstitial space between.

Embodiments of the present invention include a nail trimmer tool and methods of use of this tool. The nail trimmer tools can be utilized to trim the nails of pets, including but not limited to, the nails of canines. As described herein, examples of the nail trimmer tool include a blade that is configured to produce a three dimensional cut. Utilizing a tool with this type of blasé provides a number of advantages, certain of which are listed herein: 1) the shape of the blade enables more of an excess nail to be removed with one cutting motion; 2) while the excess nail can be removed with the single cutting motion, use of this tool avoids inadvertently cutting the internal vital structures of the nail (e.g., blood vessels and nerve tissue), which would result in bleeding and pain; 3) the singular cutting motion leaves the end of the nail rounded, rather than straight squared off, so that the resultant nail is blunter and does not include sharper and longer cut edges; and 4) the efficacy of the procedure of cutting the nail relies less on managing the subject because, based on the unique shape of the blade in the examples herein, the nail of the subject can be cut without the entire cutting blade needing to envelope, or wrap around the back of the nail. A challenge of using many pre-existing nail trimmers is that an operator must wrap the device around the nail to place the blade in the space between the caudal surface of the nail and the toe pad from which the nail originates. This placement makes trimming a nail that is in close proximity to the pad (e.g., an ingrown nail) difficult or impossible and it greatly increases the risk of painfully pinching or cutting the dog's toe pad. Because of placement limitations, certain existing nail trimming devices are ineffective in trimming ingrown nails.

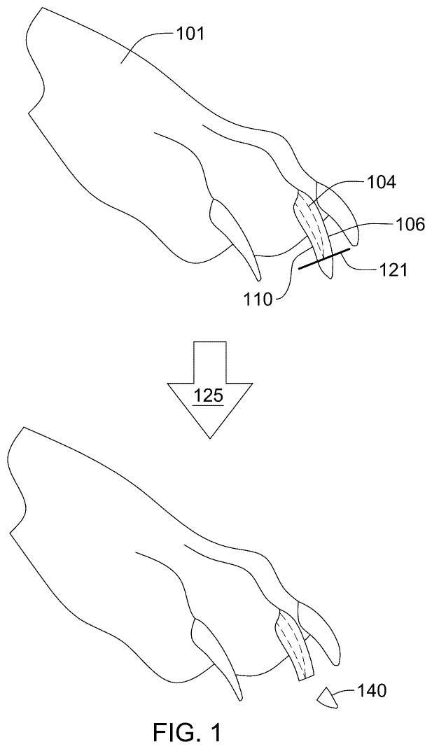

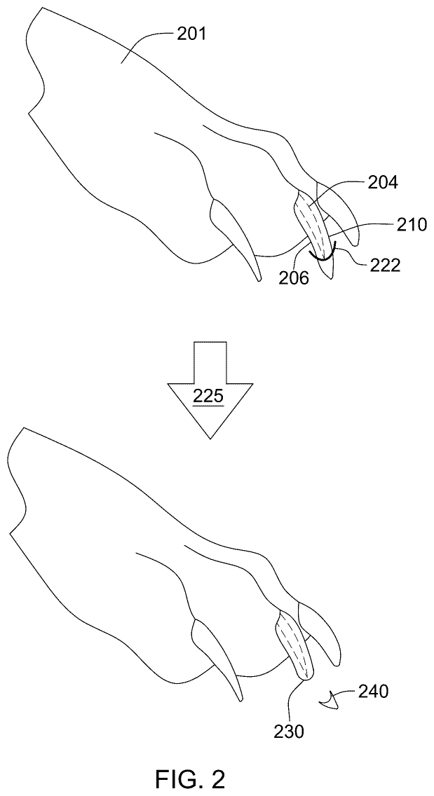

FIGS. 1 and 2 demonstrate the contrast between the techniques utilized by the present invention to trim pet nails and those utilized by existing trimmers. As aforementioned, an advantage of the existing trimmer and methods is that the resultant clipped nail is clipped into a rounded shape, which creates a blunter nail, which is safer because it cannot catch and potentially cause pain or injury. FIG. 1 illustrates a cut made by a traditional two-dimensional cutting blade. Illustrates in FIG. 1 is a paw 101 with a toenail 110 that includes a shell 106 and a quick 104. A two-dimensional straight cut margin or cut line 121, where the cut will take place, is indicated. The paw 101 is pictured both before and after the toenail 110 is cut with an existing cutting device. A blood vessel 120 is close to the end of the toenail 110. When the toenail 110 is cut (125), the trimmed portion 130 of the toenail 110 is squared off. If it is cut quickly (as is desirable given the behavior of the animal must be controlled during the process), or if the cut desired is a shorter one (for safety reasons) the quick 104 can be grazed and the paw 101 will bleed. Even if trimmed carefully, the trimmed portion 130 of the toenail 110 is still long along the corners and the edges are sharp. The clipper blades of the existing trimmer cuts the nail in close proximity to the pad of the paw 101. The blades of the trimmer (the existing trimmer) cannot contact the nail without the tip of the blade pinching the pad; this is because when using a traditional trimmer, the trimmer wraps back around the nail and encroaches on the pad. The portion of the nail that was cut 140 is also illustrated so that the shape can be contrasted with the portion of the nail that was cut 240 in FIG. 2.

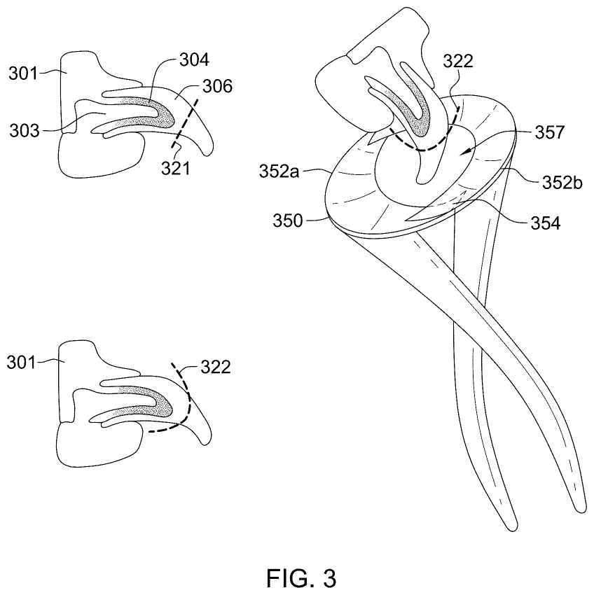

FIG. 2 illustrates the cutting of a toenail 210 of a paw 201 but with an example of the device herein and hence, the advantages of cutting the toenail 210 using the device. In contrast to FIG. 1, the cut margin or cut line 222 when utilizing the device described herein is curved (it is a three dimensional and not a two dimensional cut). Thus, when the toenail 210 is cut (225), the finished (cut) toenail 210 is rounded, so the trimmed portion 230 does not have squared off parts and the toenail 210 keeps a natural shape. Thus, the device described herein does not cut close to the quick 206 of the nail 210, unlike the example in FIG. 1. Thus, the shell 206 is what is cut (trimmed) by the device, not the quick 204. As will be discussed herein, this shape (cut) is created by the device described herein, rapidly, as preferable given the need to control the movement of the animal during the process, and the rapidity creates a safer environment for the animal. For example, when using the trimmer disclosed herein, the bladed (e.g., FIG. 3, 352a 352b) do not encroach upon pad area of the paw 201. The tips of the blades (e.g., FIG. 3, 352a 352b) does not wrap around the back of the nail and encroach on the pad. In the embodiments herein, the blades can be comprised of stainless steel, plastic, aluminum, and/or ceramic. These materials are not a comprehensive list as additional materials that can be used in nail trimming blades can also be incorporated into examples of the nail trimming tool herein.

FIG. 3 provides a comprehensive view of the nail trimming tool 350 described herein and how the nail trimming tool 350 (the blades 352a 352b of the nail trimming tool are depicted) can be utilized to cut a nail 301 of an animal. The paw 301 of the animal to be groomed includes bone 303, quick 304 (a quick is the sensitive part of the nail that contains blood vessels and nerves; it can be easily identified if a dog, for example, has clear nails because there is a visual difference between the casing or shell 306 of the dog's nail and the blood supply in the quick), and the shell 306. Also illustrated is the cut line 321, where a desired cut would take place, as it would occur with an existing cutting apparatus. Also illustrated is the cut line 322 where the nail trimming tool 350 trims the shell 306 on the nail of an animal (e.g., dog). As illustrated in FIG. 3, the nail trimming tool 350 is comprised of two blades 352a 352b configured such that there is an overlap 354 of the blades 352a 352b when the nail trimming tool 350 is in an open position. The paw 301 is situated to align the cut line 322 with a perimeter 357 formed by the blades 352a 352b. The blades 352a 352b, when closed around the shell 306, form the three-dimensional curves cut at the cut line 322. The nail margin takes the shape of the bladed plane.

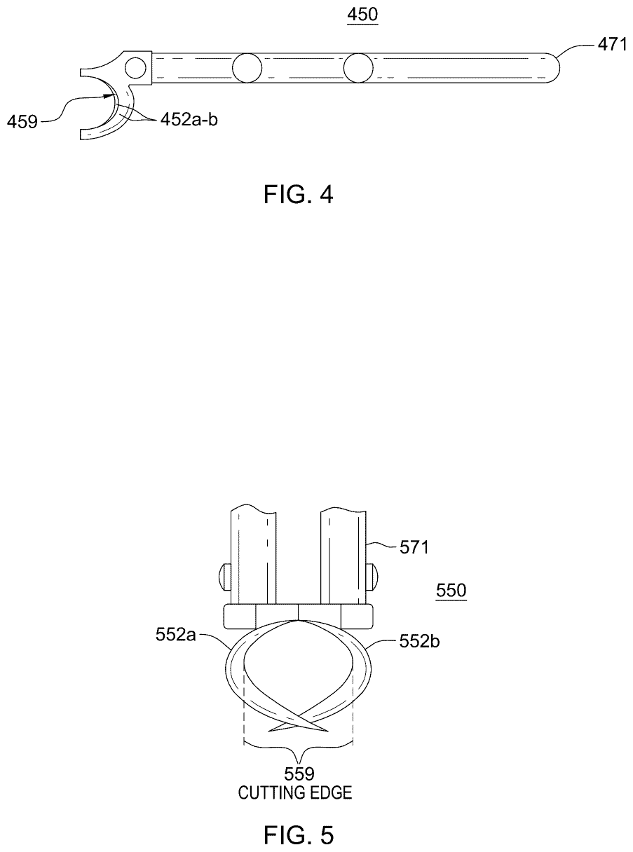

FIGS. 4-5 provide additional view of an example of the nail trimming tool 450 550 described herein. FIG. 4 is a side view of the nail trimming tool 450 that shows an attachment of a hinged handle 471 (although this is just one example of a possible type of handle) to control the blades 452a-452b. The cutting edge 459 is also illustrated. FIG. 5, meanwhile, provides a front view of the nail trimming tool 550, while also includes the cutting edge 559. Both of the blades 552a 552b can be viewed from the front and how they can close around a nail. The attachment to the handle 571 is also illustrated.

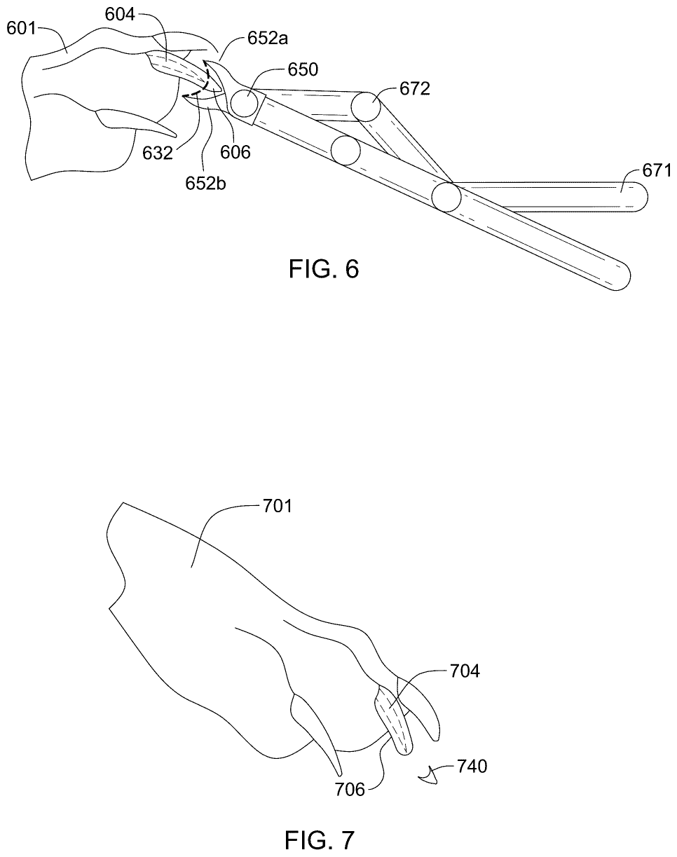

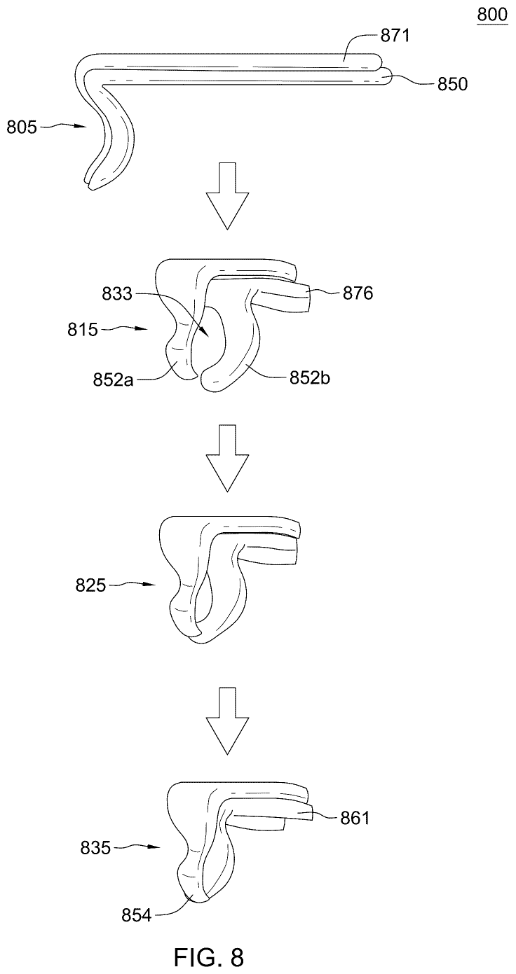

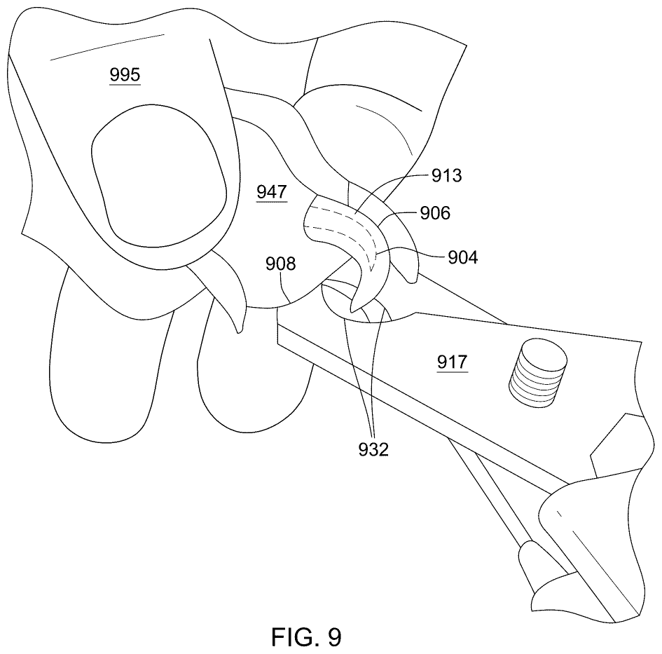

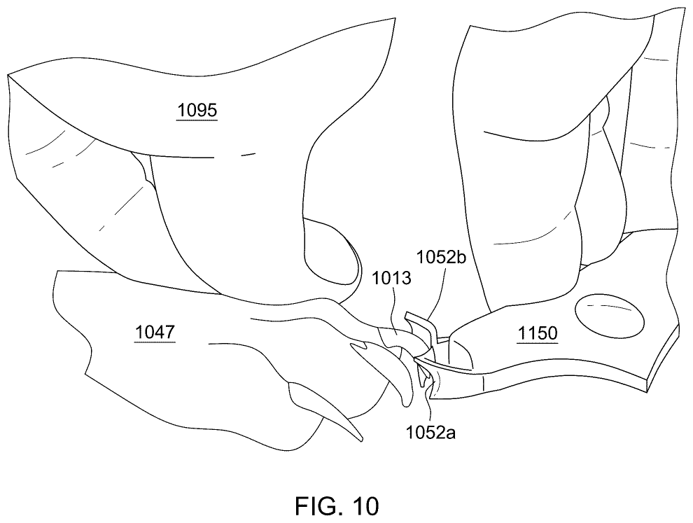

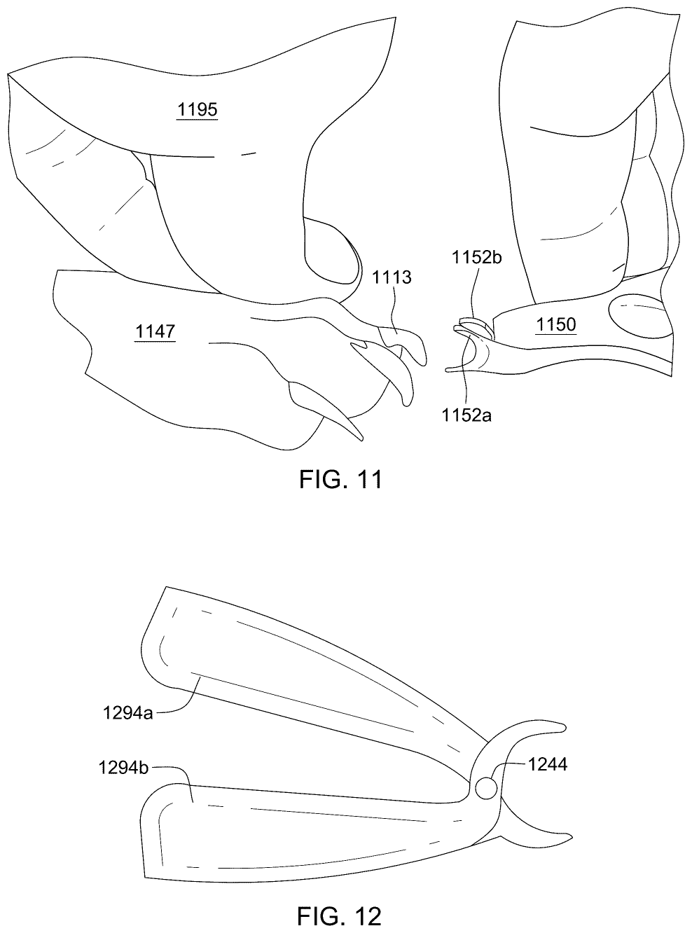

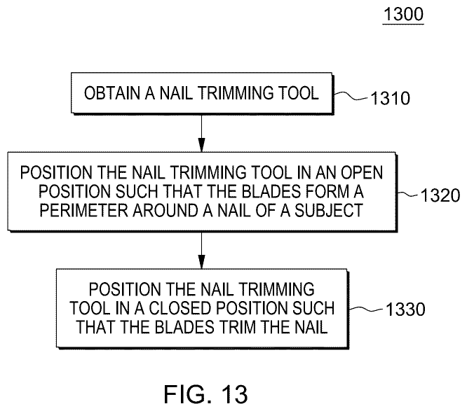

FIGS. 6-7 illustrates usage of the nail trimming tool 650. FIG. 6 illustrates the nail trimming tool 650 in the process of trimming a nail shell 606. Illustrated is the paw 601, as well as the quick 604. The cut line 632 is established by the plane formed by the blades 652a-652b when the handle 671 (including hinges 672) controls the blades 652a-652b to be in a closed position. FIG. 6 illustrates the blades 652a-652b and thus, the device itself, the nail trimming tool 650, in an open position. FIG. 7 shows a result of the cut by the nail trimming tool 650. The nail is trimmed such that the quick 704 remains undisturbed, only the shell 706 has been cut, and the piece of nail 740 that was removed from the paw 701 has a cut that is shaped like the bladed plane formed by the blades 652a-652b.

FIG. 8 illustrates the positioning of the nail trimming tool 850 as it trims a nail, hence, it illustrates a workflow 800 of the use of the nail trimming tool 850. As noted earlier, the nail trimming tool 850 includes a handle 871 that controls the operation of two blades 852a-852b. When the handle 871 is used to close the blades, forming a cut line, a nail can be cut. As seen in this figure, unlike in traditional nail cutting devices, when closed, the two blades 852a-852b are angled away from the paw of the subject (whose nails are being trimmed). Traditional devices wrap around the back of a paw and can cause damage while this nail trimming tool 850 minimized contact with any part of the paw that is not the nail shell (as illustrated in earlier figures). Returning to FIG. 8, one can position the nail trimming tool 850 at a desired location (805). A user can then utilize the handle 871 to operate the nail trimming tool 850 to open the two blades 852a-852b into an open position 876, forming an open partially circular (e.g., oval) ring 833 around the nail to be trimmed. Once the nail is in the opening (ring 833), the user can close the circular ring 833 by using the handle 871 (825) and when the two blades 852a-852b and the nail trimming tool 850 are in a closed position 861, the blades 852a-852b overlap 854 each other and cut the nail that was in the circular ring 833 (e.g., opening) alone the plane formed by the blades.

FIGS. 9 and 10-11 show the contrast in safety to the subject 947 1047 1147 whose nails are being trimmed when utilizing a traditional nail trimming device 917 (FIG. 9) and when using an example of a nail trimming tool 1050 1150 (FIGS. 10-11) described herein. As noted earlier, and illustrated in FIG. 9, when using a traditional nail trimming device 917, the entire cutting blade envelopes or wraps around the back of the nail 913 (which includes the shell 906 and the quick 904). In FIG. 9, to trim the nail 913, the operator 995 wraps the device 917 around the nail 913 to place the blade in the space between the caudal surface of the nail 913 and the toe pad 908 from which the nail originates. This procedure requires that the subject is restrainer or an injury can occur because of the proximity of the blade (including the sharp edges of the blade 932, the pad 908 of the subject 947.

FIGS. 10-11 illustrate the nail trimming tool 1050 1150 in various stages of use. As seen by the positioning of the subject 1047 1147 and the two blades 1052a-1052b 1152a-1152b, the blades 1052a-1052b 1152a-1152b do not envelope or wrap around the back of the nail 1013 1113 of the subject 1047 1147 when the operator 1095 1195 uses the nail trimming tool 1050 1150 to trim the nail 1013 1113 of the 1047 1147. One can also note that because the nail trimming tool 1050 1150 does not wrap around the back of the paw of the subject 1047 1147, the operator 1095 1195 can press the paw of the subject 1047 1147 down onto a surface rather than suspending it in the air (like in FIG. 9). Pressing the paw down is an easier orientation to maintain and can be more comfortable for the subject 1047 1147 while also keeping the subject 1047 1147 safe.

FIG. 12 is one example of a possible handle 1271 that can be utilized in the nail trimming tool described herein. In this example, the tool includes a single connector 1244 for two handle parts 1294a 1294b and operates much like a standard pair of pliers, for ease of use. An operator can open and close the blades using the two handle parts 1294a 1294b.

FIG. 13 is a workflow 1300 that illustrates the use of the nail trimming tool described herein. As noted earlier and illustrated in FIGS. 10-11, because the nail trimming does not wrap around the back of the nail, the positioning of the subject can be flexible. Referring to FIG. 13, in some embodiments of the present invention, a user obtains a nail trimming tool (examples of which are described herein) (1310). The user positions the nail trimming tool in an open position such that the blades form a perimeter around a nail of a subject (1320). In some embodiments of the present invention, the perimeter is unbroken and the blades form a full circle, but in others, there may be a space along a perimeter where neither blade is located. Thus, the blades form a space where the nail can be located. The user positions the nail trimming tool in a closed position (e.g., controlling the blades with a handle) and the blades trim the nail (1330). The resultant cut nail is a semi-circular shape and not blunt or squared off.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The flowchart and block diagrams in the Figures illustrate the architecture, functionality, and operation of possible implementations of systems, methods, and computer program products according to various examples of the present implementation. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, processes, operations, elements, and/or components, but do not preclude the presence or addition of one or more other features, integers, steps, processes, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more examples has been presented for purposes of illustration and description but is not intended to be exhaustive or limited to in the form disclosed. Many modifications and variations will be apparent to those of ordinary skill in the art. The example was chosen and described in order to best explain various aspects and the practical application, and to enable others of ordinary skill in the art to understand various examples with various modifications as are suited to the particular use contemplated.

It should be appreciated that all combinations of the foregoing concepts and additional concepts discussed in greater detail below (provided such concepts are not mutually inconsistent) are contemplated as being part of the subject matter disclosed herein at least to achieve the benefits as described herein. In particular, all combinations of claims subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

This written description uses examples to disclose the subject matter, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples without departing from their scope. While the dimensions and types of materials described herein are intended to define the parameters of the various examples, they are by no means limiting and are merely provided by way of example. Many other examples will be apparent to those of skill in the art upon reviewing the above description. The scope of the various examples should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure. It is to be understood that not necessarily all such objects or advantages described above may be achieved in accordance with any particular example. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the subject matter has been described in detail in connection with only a limited number of examples, it should be readily understood that the subject matter is not limited to such disclosed examples. Rather, the subject matter can be modified to incorporate any number of variations, alterations, substitutions or equivalent arrangements not heretofore described, but which are commensurate with the spirit and scope of the subject matter. Additionally, while various examples of the subject matter have been described, it is to be understood that aspects of the disclosure may include only some of the described examples. Also, while some examples are described as having a certain number of elements it will be understood that the subject matter can be practiced with less than or greater than the certain number of elements. Accordingly, the subject matter is not to be seen as limited by the foregoing description but is only limited by the scope of the appended claims.

What is claimed is:

1. A nail trimming tool comprising:
a first blade and a second blade, wherein the first blade forms a first crescent, wherein the second blade forms a second crescent, wherein the first blade and the second blade are oriented to mirror each other on a vertical plane, wherein a concave surface of the first blade comprises a cutting edge of the first blade and a concave surface of the second blade comprises a cutting edge of the second blade, wherein the first blade and the second blade are oriented with a space between a portion of the first blade and a portion of the second blade, wherein a nail to be trimmed by the first blade and by the second blade can be placed inside the space.

2. The nail trimming tool of claim 1, further comprising:
a handle attached to the first blade and to the second blade, wherein the handle controls the first blade and the second blade such that the first blade and the second blade move into a first position and into a second position, wherein in the first position the first blade and the second blade the space separates the first blade and the second blade and the second position, the first blade and the second blade move toward the vertical plane from opposing horizontal orientations.

3. The nail trimming tool of claim 1, wherein based on moving toward the vertical plane, the cutting edge of the first blade and the cutting edge of the second blade trim the nail to be trimmed placed inside the space.

4. The nail trimming tool of claim 3, wherein in the first handle position, a given portion of the first blade overlaps a given portion of the second blade.

5. The nail trimming tool of claim 3, wherein the space is reduced based on the moving toward the vertical plane.

6. The nail trimming tool of claim 3, wherein based on moving toward the vertical plane, a particular portion of the first blade moves parallel to a particular portion of the second blade on another vertical plane.

7. The nail trimming tool of claim 1, wherein the vertical plane runs along a diameter of the space.

8. The nail trimming tool of claim 2, wherein the first blade and the second blade move toward the vertical plane from opposing horizontal orientations to converge on the nail such that the nail is cut to be rounded at the point at which it is cut.

9. The nail trimming tool of claim 1, wherein the space is circular.

10. The nail trimming tool of claim 1, wherein the space is an oval.

11. The nail trimming tool of claim 1, wherein the first blade and the second blade are each partially encased in a protective cover such that the cutting edge of the first blade and the cutting edge of the second blade are not encased in the protective cover.

12. A method of utilizing a nail trimming tool to cut a nail of a subject, comprising:
obtaining a nail trimming tool, the nail trimming tool comprising:
a first blade and a second blade, wherein the first blade forms a first crescent, wherein the second blade forms a second crescent, wherein the first blade and the second blade are oriented to mirror each other on a vertical plane, wherein a concave surface of the first blade comprises a cutting edge of the first blade and a concave surface of the second blade comprises a cutting edge of the second blade, wherein the first blade and the second blade are oriented with a space between a portion of the first blade and a portion of the second blade, wherein a nail to be trimmed by the first blade and by the second blade can be placed inside the space; and
a handle attached to the first blade and to the second blade, wherein the handle controls the first blade and the second blade such that the first blade and the second blade move into a first position and into a second position, wherein in the first position the first blade and the second blade form the space and the second position, the first blade and the second blade move toward the vertical plane from opposing horizontal orientation;
utilizing the handle to orient the nail trimming tool into the first position;
placing the nail to be trimmed inside the space; and
utilizing the handle to orient the nail trimming tool into the second position, wherein based on orienting the nail trimming tool into the second position, the nail is clipped.

13. The method of claim 12, wherein in the first handle position, a given portion of the first blade overlaps a given portion of the second blade when forming the space.

14. The method of claim 13, wherein the space is reduced in size based on the moving toward the vertical plane.

15. The method of claim 12, wherein the clipped nail is rounded where clipped.

16. The method of claim 12, wherein placing the nail to be trimmed inside the space comprises pressing a paw of a subject comprising the nail against a flat surface.

17. A nail trimming tool comprising:
a first blade and a second blade, wherein the first blade forms a first crescent, wherein the second blade forms a second crescent, wherein the first blade and the second blade are oriented to mirror each other on a vertical plane, wherein a concave surface of the first blade comprises a cutting edge of the first blade and a concave surface of the second blade comprises a cutting edge of the second blade, wherein the first blade and the second blade are oriented with a space between a portion of the first blade and a portion of the second blade, wherein a nail to be trimmed by the first blade and by the second blade can be placed inside the space;
a handle attached to the first blade and to the second blade, wherein the handle controls the first blade and the second blade such that the first blade and the second blade move into a first position and into a second position, wherein in the first position the first blade and the second blade form the space and the second position, the first blade and the second blade move toward the vertical plane from opposing horizontal orientations;
wherein based on moving toward the vertical plane, the cutting edge of the first blade and the cutting edge of the second blade trim the nail to be trimmed placed inside the space.

18. The nail trimming device of claim 17, wherein the space is at least partially bounded by the first blade and the second blade when the first blade and the second blade are in the first position.

19. The nail trimming device of claim 17, wherein the space is eliminated when the first blade and the second blade are in the second position.

20. The nail trimming device of claim 17, wherein the first blade and the second blade are comprised of materials selected from the group consisting of: stainless steel, plastic, aluminum, and ceramic.
